(19) United States
(12) Patent Application Publication
(10) Pub. No.: US 2019/0311347 A1
(43) Pub. Date: Oct. 10, 2019

(54) CREDIT CARD PAYMENT PROCESSING METHOD AND APPARATUS

(71) Applicant: ALIBABA GROUP HOLDING LIMITED, GRAND CAYMAN (KY)

(72) Inventor: Guangda HE, HANGZHOU (CN)

(21) Appl. No.: 16/372,719

(22) Filed: Apr. 2, 2019

(30) Foreign Application Priority Data
Apr. 4, 2018 (CN) 201810299377.X

(51) Int. Cl. G06Q 20/24; G06Q 20/40; G06F 9/54

(52) U.S. Cl. CPC G06Q 20/24; G06F 9/547; G06Q 20/40

(57) ABSTRACT

Methods, systems, and apparatus, including computer programs encoded on computer storage media, for processing credit card payment are provided. One of the methods includes: receiving credit card information from a client; generating a payment token representing the credit card information and storing the payment token; sending the payment token to the client for the client to use the payment token for payment; receiving a payment request including the payment token; locating the credit card information based on the payment token; and processing the payment request based on the credit card information.

### CROSS-REFERENCE TO RELATED APPLICATIONS

This application claims priority to the Chinese patent application No. 201810299377.X filed on Apr. 4, 2018, and entitled “Credit Card Payment Processing Method and Apparatus”, which is incorporated herein by reference in its entirety.

### TECHNICAL FIELD

Embodiments of the present specification relate to the field of Internet technologies, and in particular, to a credit card payment processing method and apparatus.

### BACKGROUND

Online shopping has gradually become an important form of shopping. A user can purchase desired goods on a shopping platform. For accessing payment services, the shopping platform basically uses a checkout counter of a payment server, i.e., a checkout system provided by the payment server. With the continuous development of the industry, however, shopping platforms gradually turn to establish their own checkout counters for accessing payment services and use an API interface provided by a payment server to complete the entire payment process, so as to improve the user's payment experience and to flexibly control the payment service processing flow of checkout counters. When a checkout counter established by a shopping platform handles payments made by a user using a credit card, however, the shopping platform needs to make a significant amount of additional investments, compared with payments made by the user using a conventional debit card, to create its own PCI (Payment Card Industry) region at an application server, and also needs to make investments at later stages to maintain the PCI region, so as to meet PCI data security standards formulated by a PCI security committee. Shopping platforms create their own PCI regions for protecting the security of transmission, processing, or storage of credit card information, and therefore, a network environment needs to be created for protecting the security of transmission, processing, or storage of credit card information.

### SUMMARY

In view of the above-described technical problems, embodiments of the present specification provide a credit card payment processing method and apparatus, and the technical solution is as follows.

In one aspect, the present specification provides a credit card payment processing method applicable on a payment server. The method may include: receiving credit card information from a client; generating a payment token representing the credit card information and storing the payment token; sending the payment token to the client for the client to use the payment token for payment; receiving a payment request including the payment token; locating the credit card information based on the payment token; and processing the payment request based on the credit card information.

In another aspect, the present specification provides another credit card payment processing method applicable on an application server. The method may include: receiving a payment request from a client; and sending the payment token to a payment server for the payment server to locate the credit card information based on the payment token and process the payment request based on the credit card information. The payment request includes a payment token representing the credit card information.

In another aspect, the present specification provides another credit card payment processing method. The method may include: obtaining credit card information input by a user for payment; sending the credit card information to a payment server; obtaining a payment token representing the credit card information from the payment server; submitting a payment request, via an application server, to the payment server. The payment request includes the payment token for the payment server to locate the credit card information based on the payment token and process the payment request based on the credit card information.

In another aspect, the present specification provides a credit card payment processing apparatus. The apparatus may include: an information obtaining module configured for a client to obtain credit card information input by a user for payment, the credit card information comprising a credit card security code; an information sending module configured for the client to send the obtained credit card information to a payment server; a token generating module configured for the payment server to receive the credit card information, randomly generate a payment token representing the credit card information, and store the payment token, the payment token comprising a random combination of letters and/or numbers; a token obtaining module configured for the client to obtain the payment token generated by the payment server representing the credit card information; a request submitting module configured for the client to submit a payment request to an application server, the payment request including the obtained payment token; a request sending module configured for the application server to process the payment request and then send the processed payment request to the payment server; a token searching module configured for the payment server to receive the processed payment request, and search, in the stored payment tokens, the payment token included in the processed payment request; and a request processing module configured for the payment server to process the processed payment request according to a result of the search.

The present specification further provides a system for processing credit card payment. The system may include one or more processors; and one or more computer-readable memories coupled to the one or more processors and having instructions stored thereon that are executable by the one or more processors to perform a method. The method may include: receiving credit card information from a client; generating a payment token representing the credit card information and storing the payment token; sending the payment token to the client for the client to use the payment token for payment; receiving a payment request including the payment token; locating the credit card information based on the payment token; and processing the payment request based on the credit card information.

The present specification also provides a computer program product. The computer program product may include instructions operative to be executed by a processor to cause the processor to perform a method. The method may include: receiving credit card information from a client; generating a payment token representing the credit card information and storing the payment token; sending the payment token to the client for the client to use the payment token for payment; receiving a payment request including the payment token; locating the credit card information based on the payment token; and processing the payment request based on the credit card information.

The present specification provides another system for processing credit card payment. The system may include one or more processors; and one or more computer-readable memories coupled to the one or more processors and having instructions stored thereon that are executable by the one or more processors to perform a method. The method may include: receiving a payment request from a client; and sending the payment token to a payment server for the payment server to locate the credit card information based on the payment token and process the payment request based on the credit card information. The payment request includes a payment token representing credit card information.

The present specification provides another computer program product. The computer program product may include instructions operative to be executed by a processor to cause the processor to perform a method. The method may include: receiving a payment request from a client; and sending the payment token to a payment server for the payment server to locate the credit card information based on the payment token and process the payment request based on the credit card information. The payment request includes a payment token representing credit card information.

The present specification further provides another system for processing credit card payment. The system may include one or more processors; and one or more computer-readable memories coupled to the one or more processors and having instructions stored thereon that are executable by the one or more processors to perform a method. The method may include: obtaining credit card information input by a user for payment; sending the credit card information to a payment server; obtaining a payment token representing the credit card information from the payment server; submitting a payment request, via an application server, to the payment server. The payment request includes the payment token for the payment server to locate the credit card information based on the payment token and process the payment request based on the credit card information.

The present specification further provides another computer program product. The computer program product may include instructions operative to be executed by a processor to cause the processor to perform a method. The method may include: obtaining credit card information input by a user for payment; sending the credit card information to a payment server; obtaining a payment token representing the credit card information from the payment server; submitting a payment request, via an application server, to the payment server. The payment request includes the payment token for the payment server to locate the credit card information based on the payment token and process the payment request based on the credit card information.

According to the technical solution provided by the embodiments of the present specification, credit card information is used for exchanging with a payment server for a payment token, and the payment token is used at an application server for transmitting and completing a payment, which avoids the transmission of the credit card information at the application server, and avoids the creation of a PCI region by a shopping platform for meeting PCI data security standards formulated by a PCI security committee, thereby saving the high cost from creating the shopping platform's own PCI region and maintaining the PCI region at later stages.

It should be understood that the general description above and detailed description below are merely exemplary and illustrative, and cannot limit the embodiments of the present specification.

In addition, any one of the embodiments of the present specification does not need to achieve all of the above-described effects.

### BRIEF DESCRIPTION OF THE DRAWINGS

To more clearly describe the embodiments of the present specification or technical solutions in the current technologies, the accompanying drawings to be used in the description of the embodiments or the current technologies will be briefly described below. Apparently, the accompanying drawings in the description below are merely some of the embodiments of the present specification. Those skilled in the art may obtain other drawings based on these accompanying drawings.

FIG. 1 is a flow chart of a credit card payment processing method according to the current technologies;

FIG. 2 is a schematic diagram of interaction among three parties: a client, an application server, and a payment server, according to some embodiments of the present specification;

FIG. 3 is a flow chart of a credit card payment processing method according to some embodiments of the present specification;

FIG. 4 is a schematic structure diagram of a credit card payment processing apparatus according to some embodiments of the present specification;

FIG. 5 is a schematic structure diagram of the credit card payment processing apparatus applicable on the client according to some embodiments of the present specification;

FIG. 6 is a schematic structure diagram of the credit card payment processing apparatus applicable on the application server according to some embodiments of the present specification;

FIG. 7 is a schematic structure diagram of the credit card payment processing apparatus applicable on the payment server according to some embodiments of the present specification;

FIG. 8 is a schematic structure diagram of a device for setting up the apparatus according to some embodiments of the present specification.

### DETAILED DESCRIPTION

To enable those skilled in the art to better understand the technical solutions in the embodiments of the present specification, the technical solutions in the embodiments of the present specification will be described in detail below with reference to the accompanying drawings in the embodiments of the present specification. Apparently, the described embodiments are merely some, but not all, embodiments of the present specification. All other embodiments obtainable by those skilled in the art based on the embodiments of the present specification shall fall within the scope of the present specification.

A PCI region is a network environment created for protecting transmission and storage of credit card information so as to meet PCI data security standards formulated by a PCI security committee. All entities involving credit card processing, including merchants, processing organizations, issuers, service providers, and all other entities storing, processing, or transmitting credit card information shall create their own PCI regions, so as to ensure the security of transmission, processing, or storage of credit card information.

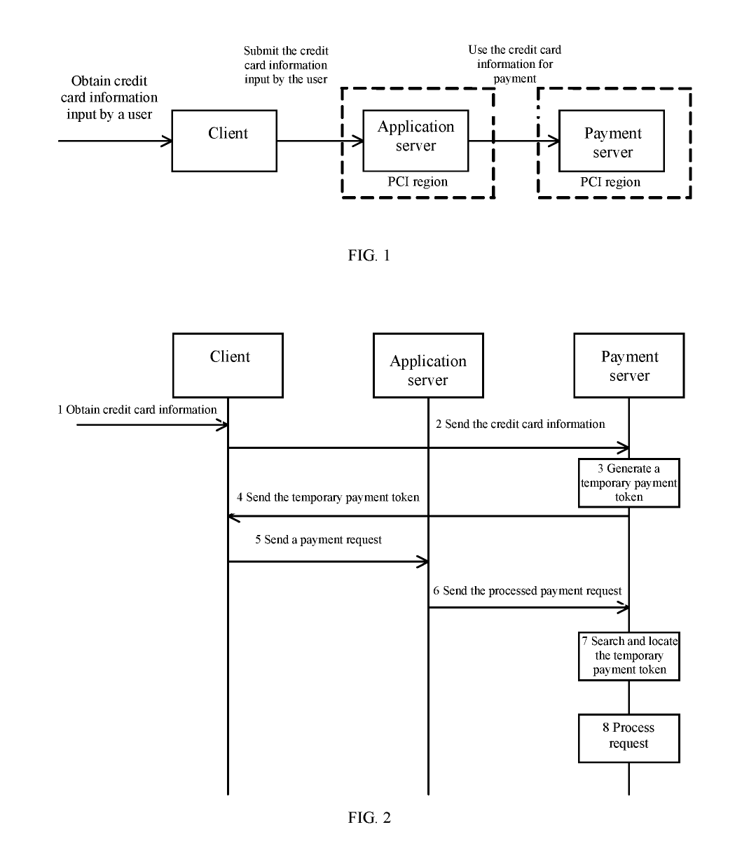

At present, with continuous development of the industry, shopping platforms gradually turn to establish their own checkout counters, so as to improve the user's payment experience and to flexibly control the payment service processing flow of checkout counters. To ensure that credit card information is not leaked and to ensure the security of transactions when users use credit cards for payments, a shopping platform needs to make additional investments to create the shopping platform's own PCI region at an application server, and also needs to make investments at later stages to maintain the PCI region, thereby leading to heavy economic burdens on the shopping platform. An existing credit card payment flow is shown in FIG. 1.

In view of the above-described problems, embodiments of the present specification provide the following technical solutions: when a user uses a credit card for payment, a client first obtains credit card information input by the user for payment and sends the credit card information to a payment server; the payment server generates a temporary payment token representing the credit card information, and uses the temporary payment token for transmitting and completing the payment at an application server. The interactive flow chart of the technical solution is shown in FIG. 2, which avoids transmission of the credit card information at the application server and avoids the creation of the shopping platform's own PCI region by the shopping platform to meet PCI data security standards formulated by a PCI security committee, thereby avoiding the high cost from the creation of the shopping platform's own PCI region and later maintenance of the PCI region.

To enable those skilled in the art to better understand the technical solutions in the present application, the technical solutions in the embodiments of the present application will be described in detail below with reference to the accompanying drawings in the embodiments of the present application. Apparently, the described embodiments are merely some, but not all, embodiments of the present application. All other embodiments obtainable by those skilled in the art based on the embodiments of the present application shall fall within the scope of the present application.

As shown in FIG. 1, in some embodiments, interacting entities involved by a payment server include a client and an application server, wherein the client may be a browser at a user side such as the Google™ browser, a shopping platform client such as the Taobao™ APP client, and the like, the application server may be a shopping platform server, and the payment server is typically in the form of a server.

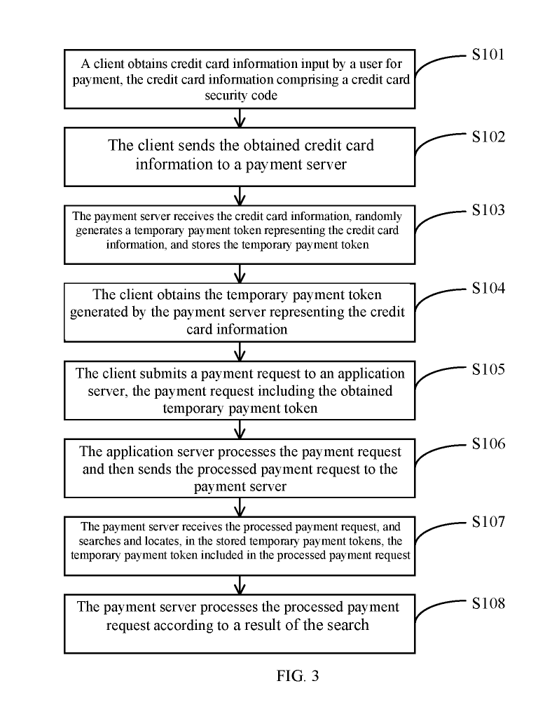

A flow chart of a credit card payment processing method according to some embodiments of the present specification is shown in FIG. 3. The method can comprise the following steps.

In step S101, a client obtains credit card information input by a user for payment, and the credit card information may include a credit card security code.

When the user has selected desired goods on a shopping platform and selected to use a credit card for payment, the user may log in a personal account via a browser or the shopping platform client on a personal terminal device, such as a mobile phone, and pay for the expense. The client can obtain the credit card information input by the user for payment, and the input credit card information may include a credit card security code. In addition, the credit card information can further include a plaintext card number, expiration year, expiration month, cardholder name, billing address, etc. In some embodiments, the user pre-binds the credit card information other than the credit card security code with the personal account, and the client just needs to obtain the credit card security code input by the user to obtain other credit card information from the personal account of the user.

In step S102, the client sends the obtained credit card information to a payment server.

The credit card information, such as a credit card plaintext card number, generally is arranged according to certain rules, and each digit in the plaintext card number may have a certain meaning. Taking a credit card security code as an example, it is generated by the plaintext card number, expiration year, expiration month, and service constraint code of the credit card through the card issuing organization's coding rules and encryption algorithms. The credit card security code typically has 3 or 4 digits and is used for checking user identity for off-site transactions. In some embodiments, after the credit card information is obtained, the credit card information is subject to preliminary verification to prevent a user from maliciously inputting invalid credit card information. For example, in the obtained credit card information, the plaintext card number is a series of sequential numbers, 123456 . . . , and the client performs preliminary verification on this plaintext card number according to the rules for arranging plaintext card numbers. When the verification fails, the client prompts the user to re-input credit card information, or prompts the user that the input credit card information is invalid information. In another example, the credit card security code in the obtained credit card information has only one valid digit, and the client performs preliminary verification on the above-described credit card security code according to valid digits of credit card security codes. When the verification fails, as described above, the client prompts the user to re-input credit card information, or prompts the user that the input credit card information is invalid information.

After the credit card information passes the preliminary verification by the client, the client sends the obtained credit card information to the payment server. In one embodiment, the payment server provides an API interface for exchanging credit card information for a temporary payment token. The client sends the obtained credit card information to the payment server via the API interface provided by the payment server to exchange for the temporary payment token. For example, the client is a browser client. The browser client uses a JS (JavaScript) asynchronous request to send the obtained credit card information to the payment server via the API interface provided by the payment server to exchange for a temporary payment token.

In step S103, the payment server receives the credit card information, randomly generates a temporary payment token representing the credit card information, and stores the temporary payment token. The temporary payment token may include a random combination of letters and/or numbers.

After the client performs preliminary verification on the credit card information, the client sends the credit card information to the payment server. Upon receiving the credit card information, the payment server needs to perform further verification on the credit card information to ensure that the credit card information input by the user is legitimate and valid.

After the credit card information passes the verification, the payment server randomly generates a temporary payment token representing the credit card information, establishes a table of corresponding relationship between the credit card information and the temporary payment tokens, and sets a valid period for the credit card information and its temporary payment token. Here, algorithms for randomly generating the temporary payment token are not limited in the present specification, and the number of valid digits comprised in the temporary payment token are also not limited in the present specification. In some embodiments, the generated temporary payment token is a combination of numbers, a combination of letters, or a combination of numbers and letters. Alternatively, based on the above description, the temporary payment token may also include special characters. For example, a temporary payment token randomly generated by the payment server is asdr01820, and the corresponding credit card information is recorded as credit card information 4. The payment server may establish a table of the corresponding relationship between the credit card information 4 and the temporary payment token asdr01820, and sets a valid period for the credit card information 4 and the temporary payment token asdr01820. The default valid period is 90 min. A generated table of corresponding relationship is shown in Table 1 below as an example.

TABLE 1

| | Temporary | Valid period |
|---|---|---|
| Credit card information | payment token | (min) |
| Credit card information 1 | 123456789 | 90 |
| Credit card information 2 | Asdfghjkl | 90 |
| Credit card information 3 | 123qwe!~* | 90 |
| Credit card information 4 | asdr01820 | 90 |

There may be several situations that can lead to the failure of the verification on the credit card information. For instance, the credit card information input by the user is incorrect, the credit card used by the user has been reported lost, the credit card used by the user is not activated or has expired, or the like. When the verification on the credit card information fails, the payment server sends to the client a message that the credit card verification fails, to cause the client to prompt the user to re-input credit card information or use another payment method. In some embodiments, according to the cause for the failure of the verification, the client prompts the user to re-input credit card information or use another payment method. For example, it is prompted in the credit card verification message that the credit card has been reported lost, and the user can be prompted to use another payment method. For example, it is prompted in the credit card verification message that the credit card information is incorrect, and the user can be prompted to re-input credit card information.

The temporary payment token in the embodiments of the present specification may be only for the current credit card transaction. A temporary payment token may be generated for each transaction. When the user uses the same credit card for another payment, another temporary payment token can be randomly generated.

In step S104, the client obtains the temporary payment token generated by the payment server representing the credit card information.

The client sends the obtained credit card information to the payment server via the API interface provided by the payment server to exchange for a temporary payment token, and then the client obtains the temporary payment token generated by the payment server representing the credit card information.

In some embodiments, the client takes the initiative to obtain the temporary payment token. For example, the client can take the initiative to request a temporary payment token representing the credit card information, at a preset time interval and via an API interface. The API interface is provided by the payment server for exchanging credit card information for the temporary payment token, and the temporary payment token is generated by the payment server representing the credit card information. In another example, the client sends the credit card information 4 to the payment server via the API interface, and at an interval of one second, the client can actively requests a temporary payment token representing the credit card information 4 until the temporary payment token is obtained.

The above-described implementation manner for obtaining the temporary payment token is merely an example and not intended to limit implementation manners for obtaining a temporary payment token.

In step S105, the client submits a payment request to an application server, and the payment request includes the obtained temporary payment token.

After the client obtains the temporary payment token corresponding to the credit card information, the client submits the payment request to the application server. The payment request may include, in addition to the temporary payment token, the payer information, user consumption amount, purchased goods, and the like.

In step S106, the application server processes the payment request and then sends the processed payment request to the payment server.

After the application server receives the payment request sent by the client, the application server processes the payment transaction flow according to the information included in the payment request, such as the user consumption amount, a list of purchased goods, payer shipping address, and other information in the payment request. The application server generates a user order according to these information, and after the user completes the payment, sends the goods purchased by the user to the payer according to the payer address. After this transaction flow is completed, the application server processes the payment request. In some embodiments, the application server may delete some unnecessary information, such as the payer shipping address, and changes the sender and receiver of the payment request, for example, the sender is changed to the application server and the receiver is changed to the payment server. After the payment request is processed, the application server sends the payment request to the payment server.

In step S107, the payment server receives the processed payment request, and searches, in the stored temporary payment tokens, to search and locate the temporary payment token included in the processed payment request.

The payment server receives the processed payment request sent by the application server, and searches, in the established table of corresponding relationship between credit card information and temporary payment tokens, to locate the temporary payment token included in the processed payment request. A relatively common searching method is traversal search, meaning that the temporary payment tokens in the established table are sequentially matched with the temporary payment token included in the processed payment request. In the above-illustrated Table 1, there are four table items of corresponding relationship, and the temporary payment token included in the processed payment request is asdr01820. The matching begins from the first item of the table, and the temporary payment token in the fourth item successfully matches with the temporary payment token asdr01820 included in the processed payment request.

In step S108, the payment server processes the processed payment request according to a result of the search.

In the established table of corresponding relationship between credit card information and temporary payment tokens, the payment server finds the temporary payment token included in the processed payment request and determines a valid period of the temporary payment token. During the valid period of the temporary payment token, the payment server obtains credit card information corresponding to the temporary payment token, and restructures the processed payment request to replace the temporary payment token included in the processed payment request with the credit card information corresponding to the temporary payment token. Then, the payment server sends the restructured payment request to the bank side for final fund settlement and to complete the payment flow. For example, in the established table of corresponding relationship between credit card information and temporary payment tokens, the payment server finds the temporary payment token asdr01820 included in the processed payment request and determines the valid period of the temporary payment token to be 90 min. When the payment server determines that the time period from the generation of the temporary payment token asdr01820 to the current time has not reached the valid period of the temporary payment token, the payment server obtains credit card information 4 corresponding to the temporary payment token asdr01820, replaces the temporary payment token asdr01820 with the credit card information 4 in the processed payment request, and sends the restructured payment request to the bank side for final fund settlement and to complete the payment flow.

According to the above description of the technical solutions of the embodiments of the present specification, credit card information is used for exchanging with a payment server for a temporary payment token, and the temporary payment token is used at an application server for transmitting and completing a payment.

The application of the technical solutions provided by the embodiments of the present specification avoid the transmission of the credit card information at the application server, and avoid the creation of a PCI region by a shopping platform for meeting PCI data security standards formulated by a PCI security committee, thereby saving the high cost from creating the shopping platform's own PCI region and maintaining the PCI region at later stages.

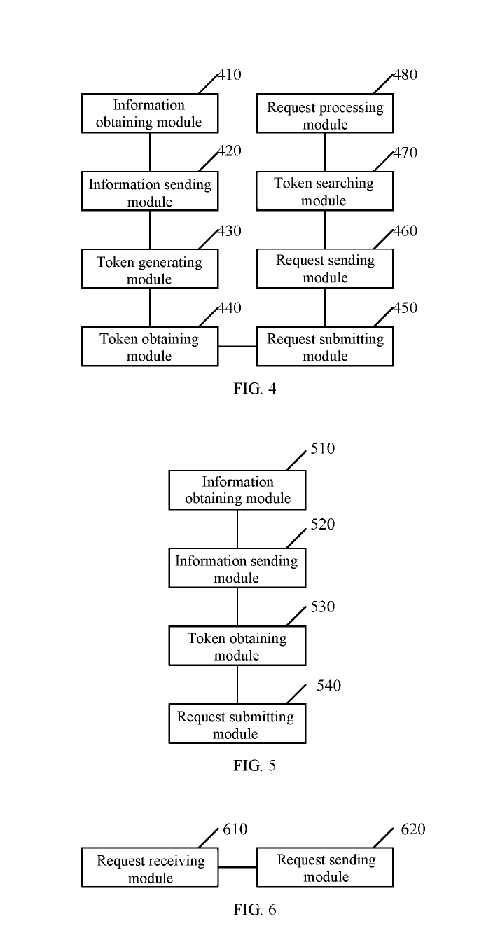

Corresponding to the above-described method embodiments, the present specification further provide a credit card payment processing apparatus. As shown in FIG. 4, the apparatus can comprise: an information obtaining module 410, an information sending module 420, a token generating module 430, a token obtaining module 440, a request submitting module 450, a request sending module 460, a token searching module 470, and a request processing module 480.

The information obtaining module 410 is configured for a client to obtain credit card information input by a user for payment, the credit card information comprising a credit card security code.

The information sending module 420 is configured for the client to send the obtained credit card information to a payment server.

The token generating module 430 is configured for the payment server to receive the credit card information, randomly generate a temporary payment token representing the credit card information, and store the temporary payment token. The temporary payment token may include a random combination of letters and/or numbers.

The token obtaining module 440 is configured for the client to obtain the temporary payment token generated by the payment server representing the credit card information.

The request submitting module 450 is configured for the client to submit a payment request to an application server, and the payment request includes the obtained temporary payment token.

The request sending module 460 is configured for the application server to process the payment request and then send the processed payment request to the payment server.

The token searching module 470 is configured for the payment server to receive the processed payment request, and search, in the stored temporary payment tokens, to locate the temporary payment token included in the processed payment request.

The request processing module 480 is configured for the payment server to process the processed payment request according to a result of the search.

According to an exemplary embodiment of the present specification, the information sending module 420 can be configured for the client to send the obtained credit card information to the payment server via an API interface provided by the payment server for exchanging credit card information for a temporary payment token.

The token obtaining module 440 can be configured for the client to obtain, via the API interface provided by the payment server for exchanging credit card information for a temporary payment token. The temporary payment token generated by the payment server represents the credit card information.

According to another exemplary embodiment of the present specification, the request processing module 480 can be configured for the payment server to search and locate, in the stored temporary payment tokens, the temporary payment token included in the processed payment request, and to determine a valid period of the temporary payment token. The valid period is a valid period set for the temporary payment token after the payment server randomly generates the temporary payment token representing the credit card information. The request processing module 480 can also be configured for the payment server to process the processed payment request during the valid period.

According to another exemplary embodiment of the present specification, the token generating module 430 can be configured for the payment server to receive the credit card information and generate the temporary payment token representing the credit card information; and for the payment server to establish a table of corresponding relationship between the credit card information and the temporary payment token. The temporary payment token may include a random combination of letters and/or numbers.

The token searching module 470 can be configured for the payment server to receive the processed payment request, and search, in the established table of corresponding relationship between credit card information and temporary payment tokens, to locate the temporary payment token included in the processed payment request.

According to another exemplary embodiment of the present specification, the apparatus may also include a prompt module. The prompt module is configured for the client to prompt the user to re-input credit card information or use another payment method, when the client receives a message from the payment server informing that the verification on the credit card information input by the user fails.

The embodiments of the present specification further provide a credit card payment processing apparatus applicable on a client. As shown in FIG. 5, the apparatus can include: an information obtaining module 510, an information sending module 520, a token obtaining module 530, and a request submitting module 540.

The information obtaining module 510 is configured to obtain credit card information input by a user for payment, and the credit card information may include a credit card security code.

The information sending module 520 is configured to send the obtained credit card information to a payment server.

The token obtaining module 530 is configured to obtain a temporary payment token generated by the payment server representing the credit card information, and the temporary payment token may include a random combination of letters and/or numbers.

The request submitting module 540 is configured to submit a payment request to an application server. The payment request includes the obtained temporary payment token, to cause the application server to process the payment request and then send the processed payment request to the payment server, for the payment server to process the processed payment request.

The embodiments of the present specification further provide a credit card payment processing apparatus applicable on an application server. As shown in FIG. 6, the apparatus can include: a request receiving module 610 and a request sending module 620.

The request receiving module 610 is configured to receive a payment request submitted by a client. The payment request includes a temporary payment token, and the temporary payment token is randomly generated by a payment server representing credit card information input by a user. The credit card information input by the user is obtained by the client and sent to the payment server. The payment token may include a random combination of letters and/or numbers.

The request sending module 620 is configured to process the payment request and then send the processed payment request to the payment server, to cause the payment server to process the processed payment request.

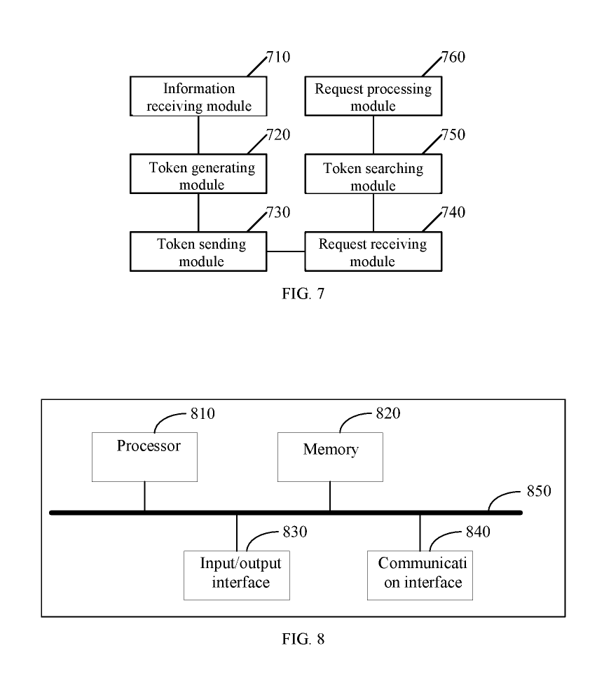

The embodiments of the present specification further provide a credit card payment processing apparatus applicable on a payment server. As shown in FIG. 7, the apparatus can include: an information receiving module 710, a token generating module 720, a token sending module 730, a request receiving module 740, a token searching module 750, and a request processing module 760.

The information receiving module 710 is configured to receive credit card information input by a user for payment from a client, and the credit card information may include a credit card security code.

The token generating module 720 is configured to randomly generate a temporary payment token representing the credit card information and store the temporary payment token, and the temporary payment token may include a random combination of letters and/or numbers.

The token sending module 730 is configured to send the temporary payment token to the client, to cause the client to send a payment request including the payment token to an application server.

The request receiving module 740 is configured to receive the payment request processed by the application server.

The token searching module 750 is configured to search, in the stored temporary payment tokens, to search and locate the temporary payment token included in the processed payment request.

The request processing module 760 is configured to process the processed payment request according to a result of the search.

For detailed implementation processes of functions and roles of the modules in the above-described apparatuses, the implementation processes of corresponding steps in the above-described methods can be referenced, which will not be elaborated in the present specification.

According to the technical solutions of the embodiments of the present specification, credit card information is used for exchanging with a payment server for a temporary payment token, and the temporary payment token is used at an application server for transmitting and completing a payment.

The application of the technical solutions provided by the embodiments of the present specification avoid the transmission of the credit card information at the application server, and avoid the creation of a PCI region by a shopping platform for meeting PCI data security standards formulated by a PCI security committee, thereby saving the high cost from creating the shopping platform's own PCI region and maintaining the PCI region at later stages.

The embodiments of the present specification further provide a computer device. As shown in FIG. 8, the device can include: a processor 810, a memory 820, an input/output interface 830, a communication interface 840, and a bus 850. Communication connections between the processor 810, the memory 820, the input/output interface 830, and the communication interface 840 inside the device are achieved through the bus 850.

The processor 810 can be implemented using a general CPU (Central Processing Unit), a microprocessor, an ASIC (Application Specific Integrated Circuit), one or more integrated circuits for executing relevant programs, etc., so as to achieve the technical solutions of the embodiments of the present specification.

The memory 820 can be implemented using ROM (Read Only Memory), RAM (Random Access Memory), a static storage device, a dynamic storage device, etc. The memory 820 can store an operating system and other application programs. When the technical solutions of the embodiments of the present specification are achieved by software or firmware, relevant program codes are stored in the memory 820 and are invoked and executed by the processor 810.

The input/output interface 830 is used to connect to an input/output module to achieve information input and output. The input/output module can be provided as a component in the device (not shown), or can be connected externally to the device to provide corresponding functions. Here, the input device can include a keyboard, a mouse, a touchscreen, a microphone, various sensors, etc., and the output device can include a monitor, a loudspeaker, a vibrator, an indicator lamp, etc.

The communication interface 840 is used to connect to a communication module (not shown), so as to achieve communications and interactions between this device and other devices. Here, the communication module can achieve communications in a wired manner (e.g., USB, a network cable, etc.) or can achieve communications in a wireless manner (e.g., a mobile network, WIFI, Bluetooth, etc.).

The bus 850 may include a path for transmitting information between components of the device (e.g., the processor 810, the memory 820, the input/output interface 830, and the communication interface 840).

Although it is illustrated that the above-described device only comprises the processor 810, the memory 820, the input/output interface 830, the communication interface 840, and the bus 850, in some embodiments, the device can further include other components required for normal operations. In addition, those skilled in the art can understand that the above-described device may only comprise components required for implementing the solutions of the embodiments of the present specification and does not need to comprise all components shown in the figures.

The embodiments of the present specification further provide a computer readable storage medium, which stores a computer program. When the program is executed by a processor, the program implements the above-described credit card payment processing method. The method includes:

obtaining credit card information input by a user for payment, the credit card information including a credit card security code;

sending the obtained credit card information to a payment server;

obtaining a temporary payment token randomly generated by the payment server representing the credit card information, the temporary payment token including a random combination of letters and/or numbers; and

submitting a payment request to an application server, the payment request including the obtained temporary payment token, to cause the application server to process the payment request and then send the processed payment request to the payment server, for the payment server to process the processed payment request.

The embodiments of the present specification further provide a computer readable storage medium, which stores a computer program. When the program is executed by a processor, the program implements the above-described credit card payment processing method. The method comprises:

receiving a payment request submitted by a client, the payment request including a temporary payment token, the temporary payment token being randomly generated by a payment server representing credit card information input by a user, the credit card information input by the user being obtained by the client and sent to the payment server, and the payment token comprising a random combination of letters and/or numbers; and

processing the payment request and then sending the processed payment request to the payment server, to cause the payment server to process the processed payment request.

The embodiments of the present specification further provide a computer readable storage medium, which stores a computer program. When the program is executed by a processor, the program implements the above-described credit card payment processing method. The method comprises:

receiving credit card information input by a user for payment from a client, the credit card information comprising a credit card security code;

generating a temporary payment token representing the credit card information and storing the temporary payment token, the temporary payment token comprising a random combination of letters and/or numbers;

sending the temporary payment token to the client, to cause the client to send a payment request including the payment token to an application server;

receiving the payment request processed by the application server;

searching, in the stored temporary payment tokens, the temporary payment token included in the processed payment request; and

processing the processed payment request according to a result of the search.

Computer readable media include permanent, volatile, mobile and immobile media, which can implement information storage through any method or technology. The information may be computer readable instructions, data structures, program modules or other data. Examples of storage media of computers include, but are not limited to, Phase-change RAMs (PRAMs), Static RAMs (SRAMs), Dynamic RAMs (DRAMs), other types of Random Access Memories (RAMs), Read-Only Memories (ROMs), Electrically Erasable Programmable Read-Only Memories (EEPROMs), flash memories or other memory technologies, Compact Disk Read-Only Memories (CD-ROMs), Digital Versatile Discs (DVDs) or other optical memories, cassettes, cassette and disk memories or other magnetic memory devices, or any other non-transmission media, which can be used for storing information accessible to a computation device. According to the definitions in the present specification, the computer readable media do not include transitory media, such as modulated data signals and carriers.

From the above description of the implementation manners, those skilled in the art can clearly understand that the embodiments of the present specification can be implemented by software plus a required general hardware platform. On the basis of this understanding, the technical solutions of the embodiments of the present specification essentially, or a part of the technical solutions that contributes to the current technologies, can be embodied in the form of a software product. The software product can be stored in a storage medium, such as ROM/RAM, magnetic discs, optical discs, etc., comprising a number of instructions to enable a computer device (which can be a personal computer, a server, a network device, etc.) to execute each of the embodiments of the present specification or the methods set forth in some parts of the embodiments of the present specification.

The system, apparatus, module, or unit elaborated in the embodiments can be achieved by a computing device. One typical implementation device is a computer, and an exemplary form of the computer can be a personal computer, a laptop computer, a cellular telephone, a camera phone, a smart phone, a personal digital assistant, a media player, a navigation device, an email receiving and transmitting device, a game console, a tablet computer, a wearable device, or a combination of several of the above devices.

The embodiments of the present specification are described in a progressive manner, and the embodiments may be mutually referenced for identical or similar parts. Each embodiment is focused on parts different from other embodiments. In particular, since the apparatus embodiments are substantially similar to the method embodiments, the apparatus embodiments are described briefly, and the description of relevant parts of the method embodiments can be referenced. The above-described apparatus embodiments are merely exemplary, wherein the modules described as separate parts may or may not be physically separated. When the solutions of the embodiments of the present specification are implemented, functions of the modules can be achieved in the same or multiple software and/or hardware. Alternatively, some or all of the modules can be selected according to actual needs to achieve the objectives of the solutions of the embodiments. One of ordinary skill in the art can understand and implement the solutions of the embodiments of the present specification without creative effort.

The above-described is only exemplary implementation manners of the embodiments of the present specification. It should be noted that, to those of ordinary skill in the art, a number of improvements and modifications can be further made without departing from the principle of the embodiments of the present specification. These improvements and modifications shall fall within the protection scope of the embodiments of the present specification.

1. A credit card payment processing method applicable on a payment server, comprising:
receiving credit card information from a client;
generating a payment token representing the credit card information and storing the payment token;
sending the payment token to the client for the client to use the payment token for payment;
receiving a payment request including the payment token;
locating the credit card information based on the payment token; and
processing the payment request based on the credit card information.

2. The method of claim 1, wherein the payment token comprises a combination of letters and/or numbers.

3. The method of claim 1, wherein the credit card information comprises a credit card security code.

4. The method of claim 1, wherein the receiving credit card information from a client comprises:
receiving the credit card information from a client via an API interface of the payment server.

5. The method of claim 1, wherein the payment token has a valid period.

6. The method of claim 1, further comprising:
storing a corresponding relationship between the credit card information and the payment token; and
locating the credit card information based on the payment token comprising:
locating the credit card information based on the corresponding relationship between credit card information and payment token.

7. A credit card payment processing method applicable on an application server, comprising:
receiving a payment request from a client, the payment request including a payment token representing credit card information; and
sending the payment token to a payment server for the payment server to locate the credit card information based on the payment token and process the payment request based on the credit card information.

8. The method of claim 7, wherein the payment token comprises a combination of letters and/or numbers.

9. The method of claim 7, wherein the credit card information comprises a credit card security code.

10. The method of claim 7, wherein the payment token has a valid period.

11. The method of claim 7, wherein the payment token is generated by the payment server based on the credit card information.

12. The method of claim 7, wherein the payment request is associated with an order received from the client.

13. A credit card payment processing method, comprising:
obtaining credit card information input by a user for payment;
sending the credit card information to a payment server;
obtaining a payment token representing the credit card information from the payment server;
submitting a payment request, via an application server, to the payment server, the payment request including the payment token for the payment server to locate the credit card information based on the payment token and process the payment request based on the credit card information.

14. The method of claim 13, wherein the payment token comprises a combination of letters and/or numbers.

15. The method of claim 13, wherein the credit card information comprises a credit card security code.

16. The method of claim 13, wherein the sending the credit card information to a payment server comprises:
sending the credit card information to the payment server via an API interface provided by the payment server to exchange for a payment token, and
the obtaining a payment token representing the credit card information from the payment server comprises:
obtaining, via the API interface, the payment token representing the credit card information from the payment server.

17. The method of claim 13, wherein the payment token has a valid period.
